(19) United States
(12) Patent Application Publication
(10) Pub. No.: US 2012/0297324 A1
(43) Pub. Date: Nov. 22, 2012

(54) Navigation Control Availability

(75) Inventors: William A. Dollar, Seattle, WA (US); Stefan K. Gordon, Redmond, WA (US); Ross D. Heeter, Seattle, WA (US); Manuel C. Ovena, Edmonds, WA (US)

(73) Assignee: MICROSOFT CORPORATION, Redmond, WA (US)

(21) Appl. No.: 13/110,636

(22) Filed: May 18, 2011

(51) Int. Cl. G06F 3/048; G06F 3/00

(52) U.S. Cl. 715/760; 715/781; 715/784; 715/800

(57) ABSTRACT

Techniques for navigation control availability are described that provide dynamic navigation controls configured to remain available throughout viewing operations including scrolling and resizing. A page of content (e.g., a webpage or document) having one or more dynamic navigation controls can be rendered within a viewing pane of a client application. Dynamic navigation controls within the page can be detected by parsing code associated with the page that defines the controls. When a viewing operation is performed that changes the display of the rendered page, the detected navigation controls can be dynamically adjusted to remain visually available according to associated behaviors. Behaviors associated with dynamic navigation controls can include, for example, docking of the controls to a visible position in or adjacent to the viewing pane, relocating of the controls, and/or resizing of the controls within the rendered page to keep the controls visible.

### BACKGROUND

Display of different items of content is typically limited by available screen size and display resolution of a display device. Therefore, large items of content that do not fit entirely within available screen area are often rendered as scrollable pages and/or across multiple pages of a site. For instance, a large technical document or book available from a website can be divided and displayed across multiple scrollable pages that can be presented in a viewing pane of a browser or other application. Various navigation controls (e.g., bookmarks, navigation bars, navigation links, etc.) for a site can be included with the pages to facilitate navigation within and between the pages.

Traditionally, navigation controls for a website are defined statically as fixed content of a page that remains in the same location relative to other content of the page. The statically defined controls can be tied to designated locations within a page such as a navigation bar that appears across the top or bottom of the page and moves through a viewing pane along with the page. Thus, statically defined navigation controls for a site can become hidden or unavailable during viewing operations, such as scrolling and/or resizing. This approach makes it inconvenient for users to access and make use of the controls for navigation, particularly when the user cannot see the controls because the controls have been navigated out of view.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Techniques for navigation control availability are described that provide dynamic navigation controls configured to remain available throughout viewing operations including scrolling and resizing. A page of content (e.g., a webpage or document) having one or more dynamic navigation controls can be rendered within a viewing pane for a client application. Dynamic navigation controls within the page can be detected by parsing metadata or other suitable code associated with the page that defines the controls. When a particular viewing operation is performed that changes the display of the rendered page, the detected navigation controls can be dynamically adjusted to remain visually available according to associated behaviors. Behaviors associated with dynamic navigation controls to keep the controls available can include, for example, docking of the controls to a visible position in or adjacent to the viewing pane, relocating of the controls, and/or resizing of the controls within the rendered page. At least some other statically defined portions of the page can be configured to become hidden in response to the particular viewing operation.

### BRIEF DESCRIPTION OF THE DRAWINGS

The same numbers are used throughout the drawings to reference like features.

FIG. 1 illustrates an operating environment in which various principles described herein can be employed in accordance with one or more embodiments.

FIG. 2 is an example user interface depicting a page having example dynamic navigation control portions in accordance with one or more embodiments.

FIG. 3 is an example user interface depicting example behaviors of dynamic navigation control portions in response to a scrolling operation in accordance with one or more embodiments.

FIG. 4 is an example user interface depicting example behaviors of dynamic navigation control portions in response to a resizing operation in accordance with one or more embodiments.

FIG. 5 is a flow diagram that describes steps of an example method in which a client causes designated navigation control portions of a page to remain visually available within the page in accordance with one or more embodiments.

FIG. 6 is a flow diagram that describes steps of an example method in which dynamic navigation control portions for pages are defined to remain visually available within user interfaces for a client application in accordance with one or more embodiments.

FIG. 7 illustrates an example computing system that can be used to implement one or more embodiments.

### DETAILED DESCRIPTION

Overview

Navigation controls for a website (e.g., bookmarks, navigation bars, navigation links, etc.) are traditionally defined statically as fixed page content that is tied to designated locations in a webpage. Accordingly, navigation controls of this type can become hidden or otherwise unavailable when viewing operations occur, such as when a user scrolls down a webpage rendered by a browser or resizes the display area. This approach makes it inconvenient for users to access and make use of the controls.

Dynamic navigation controls described herein, though, are associated with behaviors designed to keep the controls visible during scrolling, resizing, navigation within a page and/or other viewing operations that change the display of a page rendered in a viewing pane of a client application. The dynamic navigation controls can be reconfigured to remain visible in various ways that are defined by the associated behaviors. For example, behaviors applied to dynamic navigation controls in response to a viewing operation can include docking of the controls at a visible position in or adjacent to the viewing pane, relocating the controls and/or resizing of the controls to keep the controls visible.

In particular, a page (e.g., webpage or document) can be defined to include various navigation control portions including, for example, global controls for overall site navigation and local controls for navigation within content of particular pages. At least some navigation control portions of a page can be designated to remain visually available by associating the controls with behaviors. Different behaviors can be applied to prevent associated controls from becoming hidden (e.g., visually unavailable). Behaviors can be used to keep controls visible even in response to viewing operations that cause locations of a page in which the controls are initially displayed to move to hidden positions outside of the viewing pane.

For example, a browser can be used render a webpage for a support article associated with a product sold by a manufacturer. In addition to the actual content for the article, the webpage can be configured to include global controls to enable navigation of the manufacturer's website and local controls related to the article itself, such as a navigable table of contents for the support article. Either or both of the global and local controls of the example webpage can be defined as dynamic navigation controls. For instance, the controls can be defined using control definitions contained within a page and/or references within the page to control definitions available from an external source. Control definitions can be configured to identify corresponding controls, describe attributes of the controls (e.g., size, location, colors, etc.), and associate the controls with behaviors that specify how the controls respond to different viewing operations.

Accordingly, an availability module operable by a client can detect one or more dynamic navigation controls within the webpage in the above example. One way this can occur is by parsing metadata or other suitable code associated with the page that includes or references corresponding control definitions. The availability module can also apply behaviors associated with different navigation controls of the webpage when different viewing operations are performed. For instance, when a user scrolls down the example webpage for the support article, the article content and other “non-essential” portions like banners, headers, and ads can be permitted to scroll out of the viewable area. Navigation controls of the page that are defined to remain visually available, however, can be dynamically adjusted in various ways defined by associated behaviors to prevent scrolling out of the viewable area so as to maintain availability within the viewing pane. As noted, the behaviors can include docking, relocating, and/or resizing of navigation controls to keep the controls visible. In this manner, a user can be provided with persistent visual availability of navigation controls throughout the time the user views, navigates, and/or otherwise interacts with content/pages for a site.

In the discussion that follows, a section titled “Operating Environment” is provided and describes one environment in which one or more embodiments can be employed. Following this, a section titled “Example User Interfaces” describes user interfaces that illustrate example details regarding behaviors of dynamic navigation controls in accordance with one or more embodiments. Next, a section titled “Example Methods” describes example techniques for navigation control availability in accordance with one or more embodiments. Last, a section titled “Example System” describes example computing systems and devices that can be utilized to implement one or more embodiments.

Operating Environment

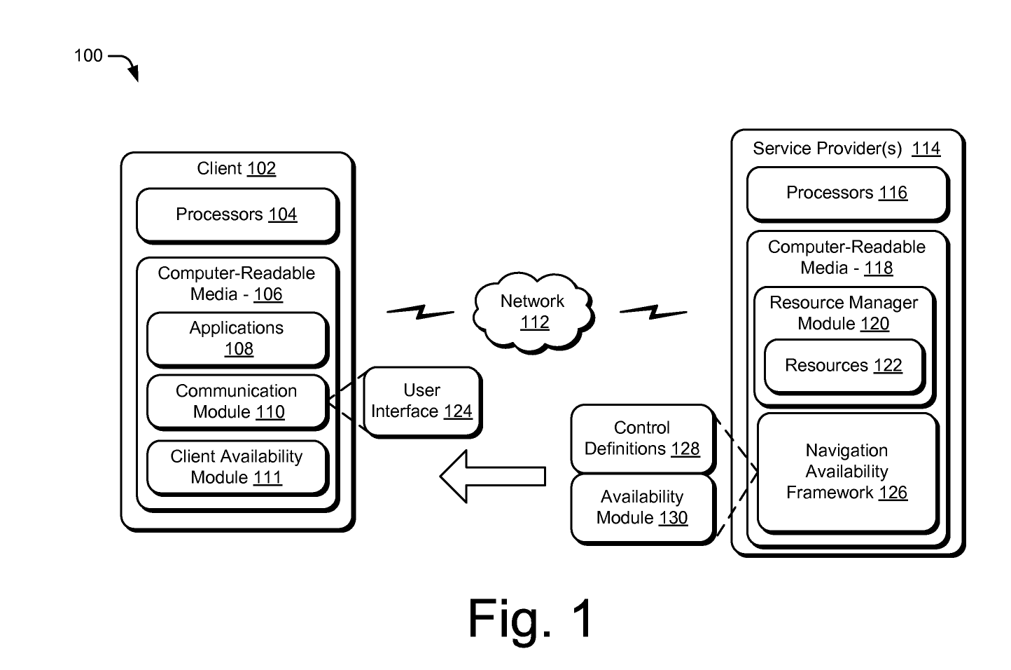

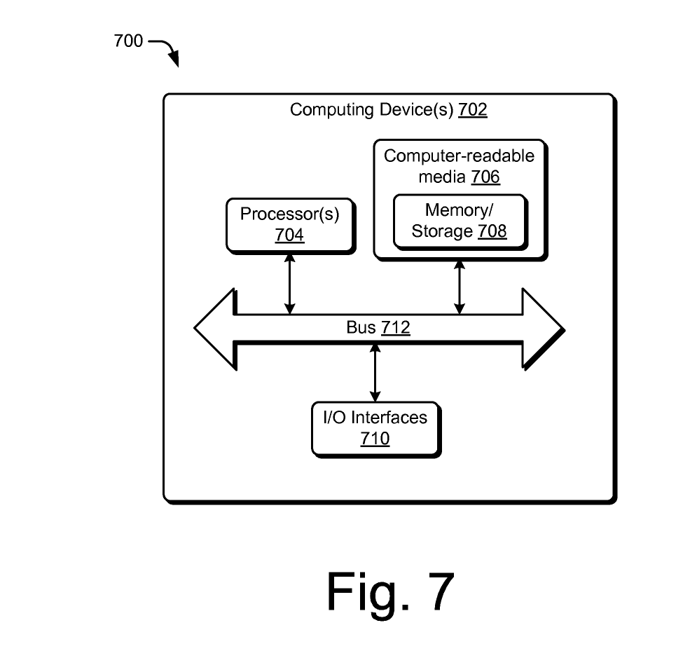

FIG. 1 illustrates an operating environment in accordance with one or more embodiments, generally at 100. Environment 100 includes a client 102 having one or more processors 104, one or more computer-readable media 106, and one or more applications 108 that reside on the computer-readable media and which are executable by the processor(s). The client 102 can be embodied as any suitable computing system and/or device such as, by way of example and not limitation, a desktop computer, a portable computer, as tablet computer, a handheld computer such as a personal digital assistant (PDA), a cell phone, a set-top box, and the like. One example of a computing system that can represent various systems and/or devices including the client 102 is shown and described below in FIG. 7.

The computer-readable media 106 can include, by way of example and not limitation, all forms of volatile and non-volatile memory and/or storage media that are typically associated with a computing device. Such media can include read only memory (ROM), random access memory (RAM), flash memory, hard disk, removable media and the like. Computer-readable media can include both “computer-readable storage media” and “communication media,” examples of which can also be found in the discussion of the example computing system of FIG. 7.

In addition, client 102 includes a communication module 110 that can be implemented in various ways. Generally, any of the techniques described herein can be implemented using software, firmware, hardware (e.g., fixed logic circuitry), manual processing, and/or a combination of these implementations. The terms “module” and “functionality” as used herein generally represent, software, firmware, hardware, fixed logic elements, and/or a combination thereof. In the case of a software implementation, the module or functionality represents instructions executable/operable by one or more hardware devices (e.g., one or more processors 104 and/or hardware logic elements) to implement techniques for navigation control availability, as well as other techniques.

The communication module 110 is operable by the client 102 to communicate and interact with various other entities (e.g., other clients, providers, servers, web sites). Interactions with other entities can include sending and receiving electronic messages in various forms (e.g., e-mail, instant messages, text messages, and so forth) between the entities, obtaining resources (e.g., content and services) from the other entities, accessing and/or downloading webpages and documents from websites, and so forth. The communication module 110 can be implemented as a standalone application, such as a web browser, and/or as a component of another application 108 that provides communication and browsing functionality to the application 108.

The communication module 110 can include a viewing pane in which pages having various kinds of content can be rendered and displayed to a viewer. The viewing pane provides a view of a rendered page and can enable scrolling through the content (e.g., links, text, images, controls, ads, etc.) within the page. Pages as used herein can include webpages and documents available online from websites. Pages can also include local documents, files, and offline pages for a web browser or other application 108.

The client 102 can also include a client availability module 111. The client availability module 111 can be distributed to the client 102 in various ways, such as by downloading over the Internet, as script in a webpage, by distribution on some form of computer-readable media or otherwise. In general, the client availability module 111 represents functionality operable by the client 102 to implement various techniques for navigation control availability. For example, the client availability module 111 can be configured to detect one or more navigation controls that are defined to remain visually available within pages for display in a viewing pane of the communication module 110 or other application 108. In response to different viewing operations, the client availability module 111 can be configured to cause the one or more detected navigation controls to remain visually available in various different ways, details of which are described in relation to the figures that follow. Because these navigation controls respond dynamically to different viewing operations (e.g., scrolling, resizing, bookmark selection, etc.), the controls are referred to as dynamic navigation controls. Navigation controls of a page (e.g., site navigation links, site navigation bars, page bookmarks, etc.) correspond to actual content defined as part of the page itself and therefore are to be distinguished from application controls (e.g., menus, scroll bars, application toolbars, etc.) that are provided for an application 108 within an application frame or window as part of the application user interface.

The client availability module 111 can be implemented as a standalone client application and/or as a component of the communication module 110, such as being implemented as an add-on for a web browser. In addition or alternatively, the client availability module 111 can be implemented as executable script according to various scripting languages that can be provided to the client 102 in conjunction with corresponding pages and/or other resources available from a service provider. Examples of suitable scripting languages that can be used to implement the client availability module 111 include, but are not limited to, JavaScript, European Computer Manufacturer's Association (ECMA) Script, Cascading Style Sheets (CSS), Extensible Markup Language (XML) or other markup language script, and Asynchronous JavaScript and XML (AJAX). The client availability module 111 can also be implemented as a web-hosted application that the client 102 can access and run in conjunction with a service provider over a network (e.g., “in the cloud”).

As further illustrated in the example environment 100, the client 102 can be communicatively coupled over a network 112, such as the Internet, with one or more service providers 114 from and to which resources (e.g., content and services) can be received and sent. The example service providers 114 of FIG. 1 are each depicted as having one or more processors 116 and one or more computer-readable media 118. A service provider 114 can be implemented by way of one or more server devices. Accordingly, various example components represented and described for a service provider 114 can be included on a single server device and/or can be divided between multiple different server devices.

Service provider 114 is depicted as including a resource manager module 120 that is operable by the service provider 114 to manage various resources 122 that may be made available over the network 112. For example, various resources 122 can be provided by way of webpages, Hyper Text Markup Language (HTML) pages, application user interfaces (UIs), or other user interfaces 124 that are communicated over the network 112 for output by the client 102 as illustrated in FIG. 1. The resource manager module 120 can manage access to the resources 122, provision of the resources 122, configuration of user interfaces 124 or data sufficient to provide the resources 122, and so on.

A service provider 114 can provide one or more web servers and/or sites (e.g., domains), which a client 102 can navigate to in order to access the resources 122. The resources 122 can include any suitable combination of services and/or content typically made available over a network by one or more providers. Some examples of services include, but are not limited to, a search service, an e-mail service to send and receive e-mail, an instant messaging service to provide instant messages between clients 102, and a social networking service to facilitate connections and interactions between groups of users who share common interests and activities. Additional examples of services include a technical support service, shopping service, a weblog service, a productivity service, an authentication service, a news service, and an advertisement service to name a few. Content may include various combinations of text, video, ads, audio, multi-media streams, animations, images, webpages, web applications, device applications, and the like.

In addition, the service provider 114 can be configured to include or otherwise implement a navigation availability framework 126. The navigation availability framework 126 represents functionality operable the service provider 114 to implement various techniques for navigation control availability. For example, the navigation availability framework 126 can be configured to facilitate creation, management, and operation of dynamic navigation controls. This can include, but is not limited to, creating navigation controls and/or control portions for pages, defining behaviors describing how the navigation controls act in response to various inputs, providing templates and/or definitions for preconfigured navigation controls, associating dynamic navigation controls with corresponding resources 122, and/or distributing client side components to the client 102 to implement the dynamic navigation controls.

For instance, the navigation availability framework 126 can include or otherwise make use of control definitions 128 that define various different navigation controls and/or associated behaviors that can be defined through the framework. The control definitions 128 can be incorporated as code embedded directly within a page definition or can otherwise be associated with pages or other resources 122 such as through references in page definitions. The navigation availability framework 126 is also depicted as having an availability module 130. The availability module 130 can represent functionality as described herein for the client availability module 111 that is implemented by the service provider 114 as a web-hosted application. In this case, a client 102 can access and run the availability module 130 in conjunction with the service provider 114 over the network 112 (e.g., “in the cloud”). The availability module 130 can also be provided to the client 102 in various ways as the client availability module 111. For example, the availability module 130 can be provided to a client as a standalone application for download, as a component or add-in for another application, as script in connection with a page or other resource, or otherwise. In this case, the availability module 130 represents the client availability module 111 prior to download, installation, and/or execution by a client 102.

Definitions for pages can incorporate control definitions 128 and/or script that is configured to implement the client availability module 111. In addition or alternatively, a page can be configured to include uniform resource locators (URLs), markup code, and/or other suitable references to control definitions 128 that can be employed to dynamically obtain, render, and make use of corresponding navigation controls from an external source when the page is rendered. In at least some embodiments, the navigation availability framework 126 can manage and provide access to a database of control definitions 128 that developers can incorporate into page descriptions directly or indirectly through references to the database. The navigation availability framework 126 can expose the database of control definitions 128 to clients over the network 112, such that the control definitions 128 are available to dynamically render pages that include references to the database. Further details regarding these and other aspects of techniques for navigation control availability can be found in relation to the following figures.

Having described an example operating environment, consider now a discussion of example user interfaces that depict example details of dynamic navigation controls and behaviors for the controls in accordance with one or more embodiments.

Example User Interfaces

This section describes example implementation details regarding dynamic navigation controls and behaviors that can be applied to dynamic navigation controls in the context of example user interfaces. The depicted user interfaces represent examples of a user interface 124 that can be output via a client 102 by way of a communication module 110 or other suitable application 108 of a client.

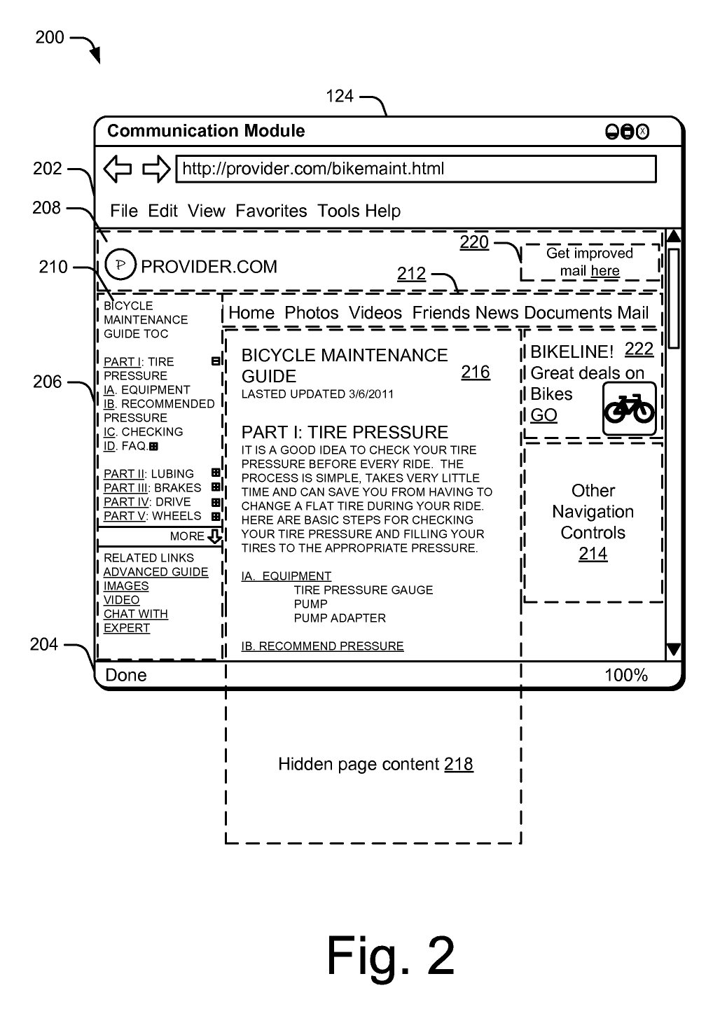

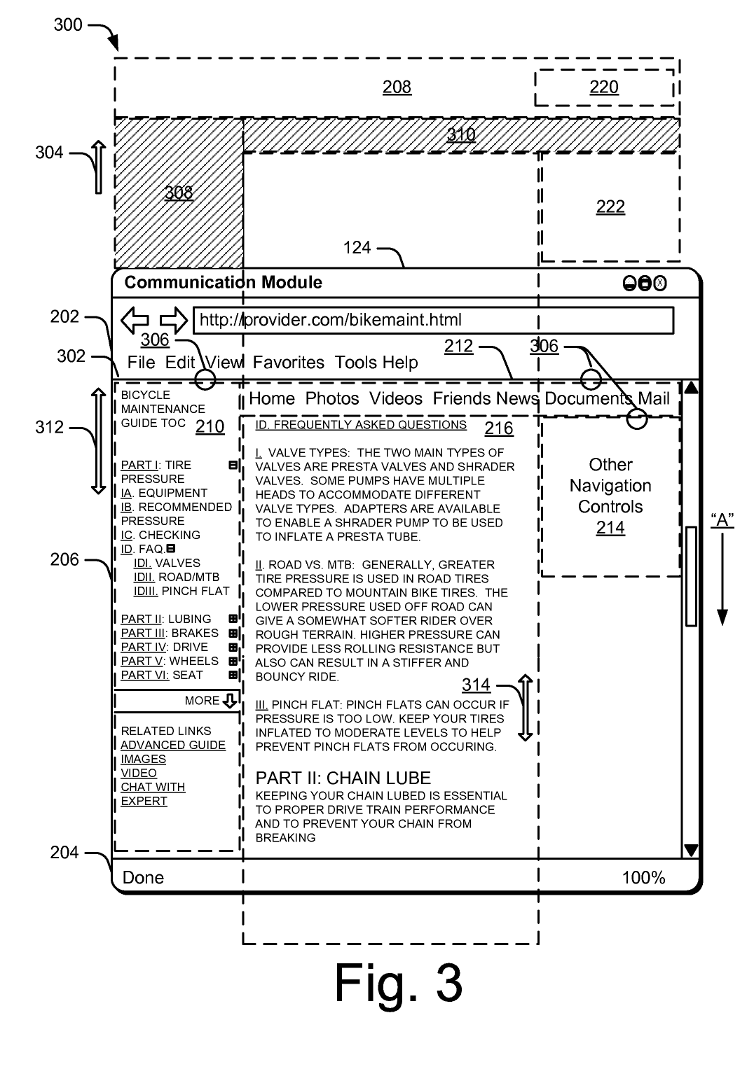

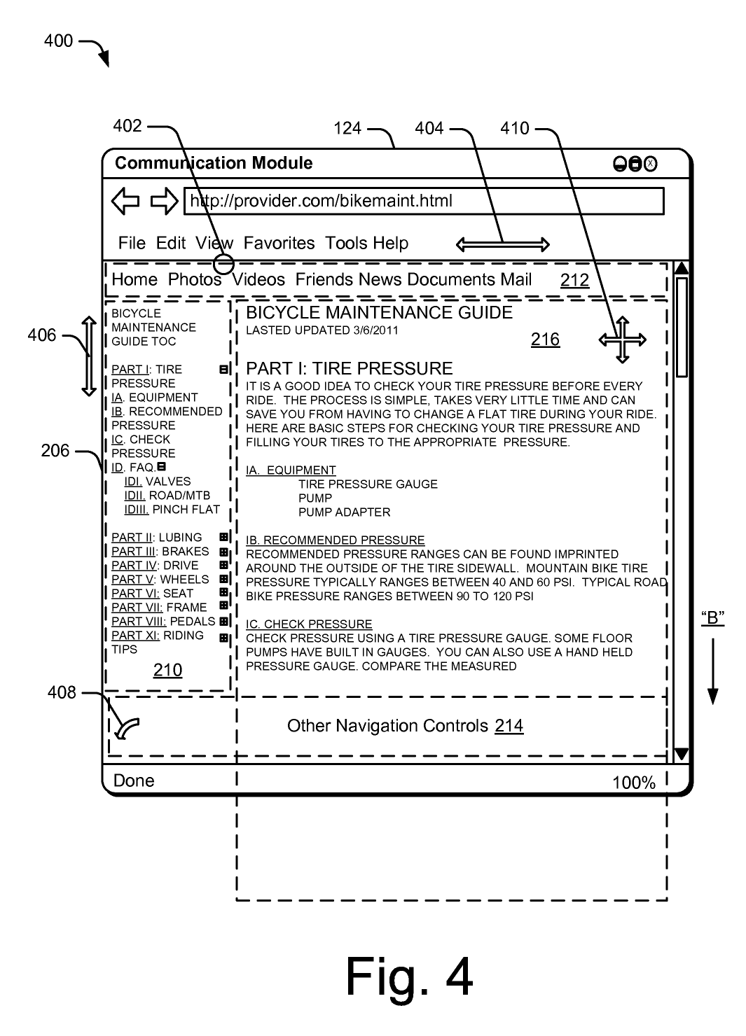

FIG. 2 depicts, generally at 200, one example of a user interface 124 for a communication module 110 that includes dynamic navigation controls for a rendered page in accordance with one or more embodiments. The rendered page represents the way a page and content within the page may initially be rendered to appear within the user interface. FIGS. 3 and 4 that follow represent changes that can occur to the user interface of FIG. 2 in response to example viewing operations of scrolling and resizing, respectively.

In FIG. 2, the example user interface 124 includes a header 202 and a footer 204 that are provided as part of an application frame or window for an application, which in this example is configured as a web browser. The application frame can incorporate menus, toolbars, scroll bars, and/or other controls for a corresponding application. The header 202 can include application controls such as the depicted navigation arrows, address bar, and menu bar for the browser. The footer 204 can contain additional controls and information such as page data, viewing controls, and the like.

The application frame can also contain a viewing pane 206 in which obtained pages, documents, and/or content for a corresponding application can be rendered for viewing. The viewing pane 206 provides an area contained within the application frame to present content, generally between the header 202 and the footer 204. In this case, an example page related to bicycle maintenance is depicted as being displayed within the viewing pane 206. The page also includes a page banner 208 that can be provided at the top of the page to identify the page and provide introductory information. The example page banner 208 includes a name and a logo for a provider of the page and/or a corresponding domain, namely “Provider.com.”

The page further includes local navigation controls 210, global navigation controls 212, and other navigation controls 214. Any combination of one or more of these example types of navigation control portions as well as other types of navigation controls can appear within a particular page. Navigation controls provided within a page can be arranged in different locations within a page and relative to one another, of which the depicted arrangement is but one example. Some or all of the navigation controls within a page can be defined as dynamic controls that are designed to remain available within the viewing pane 206. Dynamic navigation controls can be defined to respond to viewing operations independently of locations within a page in which they may appear. For instance, as content scrolls through the viewing pane and locations within the page become hidden outside the viewable area of the viewing pane 206, the controls and/or page can be reconfigured to keep the controls visible.

Local navigation controls 210 are controls related to navigation of and/or interaction with a particular item of content that is rendered within the page. Navigation controls can include but are not limited to links, navigation trees, buttons, search boxes, and other selectable user interface instrumentalities that facilitate various navigation operations for a page and/or site. For example, if a video is presented, the local navigation controls 210 controls can relate to video operations such as play, rewind, stop, record, a video content menu, and so forth. If a document, such as the example bicycle maintenance guide is presented, the local navigation controls 210 can be related to navigation within the document and/or different portions of the document. Thus, the local navigation controls 210 can contain various controls that are related in some manner to content items that are displayed. In the illustrated example, the local navigation controls 210 are illustrated as a table of contents that provides a navigable tree of links or bookmarks to different portions of the bicycle maintenance guide. The local navigation controls 210 also include a related links section configured to provide additional information related to the rendered content, such as the depicted links to an advanced guide, images and videos, and an expert chat option.

The global navigation controls 212 are controls related to navigation between and among different pages, site sections, distinct services, content items, and other resources 122 provided on a domain or site wide level. In other words, the global navigation controls 212 can be configured to provide controls for internal navigation of various resources connected with a website and/or provider of the website. The global navigation controls 212 can also include external links or other controls for navigation of partner and/or third-party sites. In this example, the global navigation controls 212 are configured as a navigation bar for a domain associated with the provider “Provider.com.” Although the example navigation bar appears generally towards the top of the example page, global navigation controls 212 can be provided at various locations within a page.

Other navigation controls 214 represent additional portions of the page that can optionally be provided in addition to the local and global navigation controls. For example, the related links portions depicted as part of the local navigation controls 210 could alternatively be provided by way of a separate portion for other navigation controls 214 in a different location within a page. Some global navigation controls could also be provided in a portion for other navigation controls 214. For example, an other navigation controls portion 214 can be configured as a global navigation bar across the bottom of a page similar to the example global navigation controls 212 depicted generally at the top of the page in FIG. 2. Other navigation controls 214 can also be configured to provide other types of controls for navigation and interaction with page content such as listing related documents or content items, providing a user's favorites menu, containing content recommendations from a provider or social network based on or related to the particular page, presenting sponsored links, and so forth.

A variety of other types of content portions can be included in the page in addition to navigation controls. For example, a page content portion 216 provides an area in which the main content of the page is presented, in this case the content of the example bicycle maintenance guide page. FIG. 2 also shows hidden page content 218 that represents content for a page that does not fit within the available area of the page content portion 216, extends outside of the viewable region of the user interface, and therefore can be hidden outside of the viewing pane 206. Page portions can also include advertisements, notices, graphics, videos, and promotions, to name a few additional examples. For instance, the example page is illustrated as having an example promotional portion 220 with a promotional offer from the provider within the banner 208 and an example advertisement portion 222 having an ad for an online bike retailer within the page.

In operation, viewing operations as described herein can be performed upon the example interface of FIG. 2 that cause a change in the way in which the page content is displayed. For example, viewing operations can change the locations of a page that are visible and hidden. The viewing operations can also trigger behaviors associated with different content portions. The behaviors are configured to direct the way in which the portions and corresponding controls respond to the viewing operations. Behaviors can be implemented to cause associated controls to respond to viewing operations in various ways. As mentioned previously, the behaviors can include, but are not limited to, docking of the controls at a visible position in or adjacent to the viewing pane, resizing the controls, and/or relocating of the controls to maintain availability of the controls.

For example, a navigation bar having global navigation controls 212 can be docked at the top of the viewing pane 206 when content for the page is scrolled through the viewing pane 206. The docking can involve detaching the navigation bar from the page and/or locking the navigation bar at a fixed position so the navigation bar remains visible on top of scrolling page content. While the navigation bar is docked, other content of the page can be scrolled past the docked navigation bar and out of view. The navigation bar could also be moved to another location and/or resized in response to scrolling or other viewing operations such as resizing of the application window, bookmark selection or other navigation within a page, gestures to manipulate content presented on a touch screen device, and so forth.

In this manner, behaviors can be associated with the local navigation controls 210, global navigation controls 212, and/or other navigation controls 214 to cause these portions to remain visually available in the viewing pane 206. The behaviors enable portions of a page to be defined to remain available persistently when selected viewing operations occur and/or for the entire duration in which a page is displayed. Other content portions that are not configured to remain available can become hidden in response to some viewing operations. For example, the promotional portion 220, advertisement portion 222, and some of the page content portion 216 can be hidden outside of the viewable area of a page.

To illustrate further details regarding behaviors and responses of content portions to viewing operations, consider now an example scenario of FIG. 3 in which scrolling occurs to change the displayed page presented in the example of FIG. 2. In particular, FIG. 3 depicts, generally at 300, the example user interface 124 following a scrolling operation designated by the arrow labeled “A”. Various example behaviors for dynamic navigation control portions that can occur in response to a scrolling operation and/or other viewing operations are represented in the example scenario.

For instance, here the scrolling operation occurs to scroll content of the page vertically through the viewing pane 206. Thus, the vertical location of the page at a boundary point 302 can change. In the depicted example, the boundary point 302 generally corresponds to the boundary across the user interface 124 between the viewing pane 206 and header portion 202 of the user interface. Other boundary points can be defined for other pages and/or for different content portions individually at any suitable position within the user interface 124 including at the top, middle, bottom, left, and/or right of the viewing pane 206. A boundary point 302 can be defined to set a position at which page content ordinarily transitions from being visible or hidden. For dynamic portions, though, a boundary point 302 can trigger behaviors that are designed to prevent the dynamic portions from becoming unavailable and adjust the dynamic portions accordingly.

Thus, as scrolling occurs, portions of the page that scroll upward through the viewing pane 206 past the example boundary point 302 can become hidden (e.g., visually unavailable) outside of the viewable area within the viewing pane 206. As represented by the arrow 304, the page banner 208, promotional portion 220, and advertisement portion 222 have scrolled pasted the boundary point 302 and have been permitted to become hidden. These portions represent portions that are not associated with behaviors that cause them to remain available.

In contrast, portions that are associated with behaviors to cause them to remain available respond to the scrolling in a manner specified by the associated behaviors (e.g., docking, resizing, relocating, etc.). Such portions can be dynamically rendered to maintain availability when a trigger occurs that causes a client availability module 111 to reconfigure and/or re-render the page in the manner specified by behaviors for the portions. Triggers can include initiation of a viewing operation, triggers caused at a boundary point, and other suitable triggers. In the example case, the global navigations controls 212, local navigation controls 210, and other navigation controls 214 have been prevented from becoming unavailable and remain accessible in the viewing pane 206, even though locations of the page in which they initially appeared in FIG. 2 have scrolled through the viewing pane 206 past the boundary point 302.

By way of example, FIG. 3 illustrates docking of the global navigation controls 212, local navigation controls 210, and other navigation controls 214 at respective docking positions 306 in the user interface 124. In particular, the global navigation controls 212 and local navigation controls 210 are depicted as being docked at the boundary point 302. The other navigation controls 214 appear as being docked at a position just below the global navigation controls 212.

Docking of controls at a visible position can occur in any suitable way. In general, docking involves locking the controls at a fixed position within or adjacent to the viewing pane. The docked controls remain visible and scrolling content can scroll underneath and/or past the docked controls to and from positions hidden outside the viewing pane. In one approach, initiation of a scroll (or other operation) can cause one or more navigation controls to become docked immediately at respective positions. Controls can be docked at their current positions or can be relocated to a designated position defined by a corresponding behavior in a single movement that appears substantially instantaneous to a viewer. In this case, the transition of controls to the docking positions 306 can occur without depicting intermediate scrolling or movement of the controls to reach the docking positions 306.

In another approach, a portion to be docked can initially scroll or move along with the page until a corresponding boundary point 302 is reached. At this point, the portion is effectively detached from its location within the page and becomes docked at the corresponding docking position 306 thereby remaining visually available. Once a portion is docked, other portions of the page content that are not defined to remain available can continue to scroll past the docked portion to hidden positions as shown at 304. When scrolling occurs back in the other direction, a docked portion can become reattached to an appropriate location within the page and scrolled back to its initial or default location within the page.

Generally speaking, the behaviors can be configured to adjust/reconfigure navigation controls in any suitable manner that maintains the availability of the controls in response to viewing operations that might otherwise cause the controls to become unavailable (e.g., scroll out of view or become hidden) were they to be defined as static controls. In this way, dynamic navigation controls that are defined to remain available can be prevented from becoming hidden or unavailable in response to the viewing operations. To further illustrate this aspect, hatched areas 308, 310 are shown in FIG. 3 to represent page locations corresponding to the locations within the page of the local navigation controls 210 and global navigation controls 212 as presented in FIG. 2. Due to the scrolling operation “A,” the page locations represented by the hatched areas 308, 310 have become hidden outside of the viewable area of the user interface 124. Thus, the hatched areas 308, 310 represent hidden (e.g., unavailable) positions of a page in which the local navigation controls 210 and global navigation controls 212 would otherwise become hidden were these controls defined as static controls rather than being dynamic navigation controls. Because the controls are defined as dynamic navigation controls, however, corresponding behaviors have been applied to the controls in response to the scrolling. Now, instead of being hidden in the hatched areas 308, 310, the local navigation controls 210 and global navigation controls 212 are docked within the viewing pane 206 as depicted in FIG. 3.

FIG. 3 also illustrates resizing of dynamic portions that can occur to make use of additional space that can be freed up when some other content portions are scrolled to hidden positions or otherwise become unavailable. In particular, the arrow 312 represents resizing to expand the local navigation controls 210 to fill the space between the header 202 and footer 204. This expansion is able to occur because (1) the local navigation controls 210 remain available at the docking position 306 and (2) additional area in the viewing pane 206 is freed up when the banner 208 and/or other portions are scrolled and become hidden. For example, the availability module 111 can determine that “non-essential” page content such as ads have been scrolled or otherwise moved out of view thereby creating more space for content in the viewing pane 206. In response, the availability module 111 can apply behaviors to resize, relocate, and/or reconfigure content of the page to take up the available space. Thus, dynamic navigation controls can be expanded to take up additional space created when other content (e.g., content not defined to remain available) is hidden. Dynamic navigation controls can also be compacted into a mini-mode to take up less space, but still remain available in some scenarios.

Note also that the content presented within the resized portion can also change. Content that appears within a resized portion can be selected based at least in part upon the content displayed in the page display portion 216. This can include rendering additional links, text, controls, and so forth that correspond to the displayed content in the page content portion 216. In other words, the presented navigation controls and page content can be interrelated. Here for example, the page has been scrolled to a frequently asked questions (FAQ) portion of the page. Accordingly, the FAQ portion of the table of contents in the local navigation controls 210 has been automatically expanded based upon the corresponding displayed position of the page.

Within the page display portion 216, additional space for content is also created when the banner 208 and/or other portions are scrolled and become hidden. The arrow 314 represents that content displayed within the page display portion 216 changes as the page is scrolled up and down. In the example of FIG. 3, content that was previously represented in FIG. 2 by hidden page content 218 is now displayed based on the scrolling. There is also more space for content within the page display portion 216. When scrolling occurs in the other direction, some hidden content can again become visible and/or the visible area of page display portion 216 can become smaller as the banner 208 and/or other portions return to their initial or default positions as shown in FIG. 2.

Further details regarding behaviors and responses to viewing operations are described with reference to another example user interface of FIG. 4. In particular, FIG. 4 depicts, generally at 400, the example user interface 124 following a resizing operation designated by the arrow labeled “B”. Here the resizing “B” involves expanding the viewing pane 206 downward. Naturally, the user interface can also be resized in a different direction (left or right) or in multiple directions. Resizing for a page can occur based upon display settings when a page is rendered, when display settings are changed, or in response to direct user input to resize an application window, such as by selecting and dragging the window or otherwise.

Resizing can also be configured to trigger behaviors that are designed to cause dynamic controls to remain available and/or adjust in different ways to effectively use the available window space. In the illustrated example, the resizing can be performed to view additional content that is hidden in the example of FIG. 2. This can trigger behaviors to reconfigure the page to display as much content as possible while still maintaining the availability of dynamic navigation controls. Again, this can include docking, relocating, and/or resizing of portions that remain available in the display. Naturally, other portions can also become hidden. The change between the initial page view of FIG. 2 and the example resized view of FIG. 4 can occur with intermediate visual transitions and/or in a manner that appears substantially instantaneous to a viewer.

By way of example, in response to the resizing operation “B” of FIG. 4, content portions that are not configured to remain available become unavailable. For instance, the banner 208, promotional portion 220, and advertisement portion 222 have become hidden. Rather than being scrolled to hidden positions as in the previous scenario, these portions can simply be closed out, placed in the background, or otherwise be hidden when the resize is initiated.

FIG. 4 further illustrates docking of the global navigation controls 212 at a docking position 402. The global navigation controls 212 have also been relocated to the top of the viewing pane 206 and have been resized to extend across the viewing pane 206 as represented by the arrow 404. The local navigation controls 210 in this case are depicted as being docked just below the global navigation controls 212 and have again been expanded to take up additional space as represented by the arrow 406.

In another example of a behavior that can be associated with a dynamic portion, the arrow 408 represents relocation of the other navigation control portion 214 from the right side to the bottom of the viewing pane 206. This can occur to make additional room for display of content in the page content portion 216. The other navigation control portion 214 has also been resized to extend across the viewing pane 206 and has been docked to the bottom. The arrow 410 represents resizing of the page content portion 216 to make use of the space created by applying the various behaviors to adjust the different navigation control portions.

In accordance with the foregoing, a variety of behaviors including the examples just described can be defined and can be applied when different viewing operations occur to maintain availability of dynamic navigation controls within a user interface. Having considered example user interfaces for navigation control availability, consider now example methods for navigation control availability in accordance with one or more embodiments.

Example Methods

The following section provides a discussion of flow diagrams that describe steps of example methods for navigation control availability in accordance with one or more embodiments. The methods can be implemented in connection with any suitable hardware, software, firmware, or combination thereof.

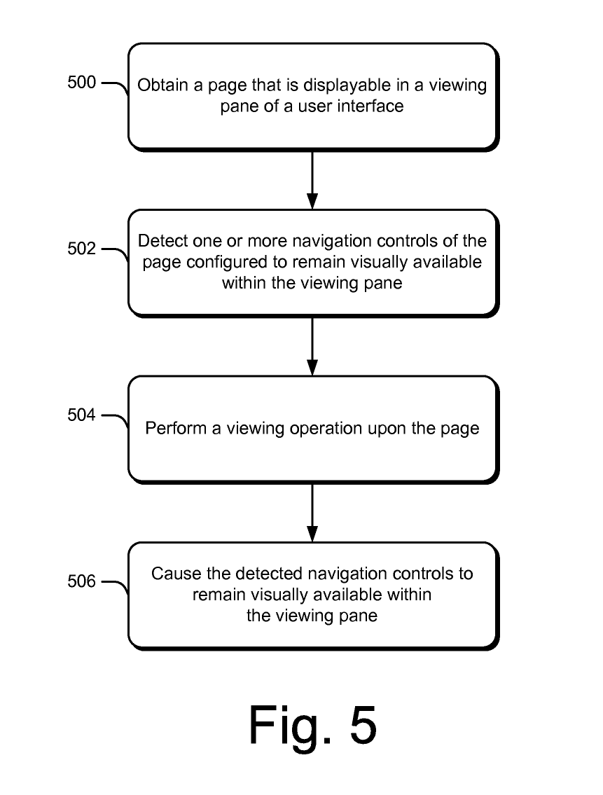

FIG. 5 is a flow diagram that describes steps of a method in which a client causes navigation control portions of a page to remain visually available within the page. In at least some embodiments, the method can be implemented by way of a suitably configured computing device, such as the example client 102 of FIG. 1 that includes or otherwise makes use of a client availability module 111.

Step 500 obtains a page that is displayable in a viewing pane of a user interface. For example, a client 102 can interact with a service provider 114 to obtain various webpages associated with resources 122 available from the service provider. Pages can be received from the service provider 114 in response to requests for the resources 122. Offline pages and/or documents available locally for different applications 108 can also be obtained from a suitable storage location at the client 102. A communication module 110 can operate to output a user interface 124 configured to browse and/or view the obtained pages and corresponding content. In accordance with techniques discussed herein, at least some pages obtained and rendered by a client 102 can be configured to include navigation controls that are designed to remain available within the viewing pane. Statically defined portions of a page can be configured to respond to viewing operations in traditional ways including becoming hidden outside of a viewable area of the viewing pane.

Step 502 detects one or more navigation controls of the page configured to remain visually available within the viewing pane. Detection of navigation controls that are dynamic can occur in any suitable way. It should be noted that the detection can occur before, after, or as part of the page rendering. One way this can occur is through operation of a client availability module 111. For example, the client availability module 111 can parse XML, metadata, and/or other suitable code for a page to identify one or more control definitions 128 associated with the page. This can include identifying embedded control definitions 128 and/or references to control definitions available from an external source, such as via a database maintained by a service provider 114 or locally.

The client availability module 111 can employ the control definitions 128 to maintain availability of designated controls when viewing operations are performed. In particular, step 504 performs a viewing operation upon the page. A viewing operation can be performed responsive to receiving input to cause the viewing operation. Viewing operations can include, but are not limited to, scrolling of content presented in a user interface, resizing of the application window and/or display area, zooming in or out, gestures applied to a touch screen to manipulate rendered content, and selection of a bookmark or other link to navigate within or between pages of a site/domain, to name a few examples. Other viewing operations and combinations of multiple operations can also be configured to cause navigation controls and control portions to respond dynamically in accordance with associated behaviors.

Initially, a page that is rendered can display various content portions that are visible in the viewing pane of an application user interface. Content portions can be configured to be rendered at different respective locations within a page (e.g., horizontal and/or vertical positions within the page). Thereafter, a user can interact with the application user interface and can provide input to perform a viewing operation that changes the displayed content in some manner. The viewing operations can cause some locations of a page that are currently displayed to become hidden (e.g., visually unavailable) and/or some hidden locations of the page to become displayed (e.g., visually available).

In connection with a viewing operation, step 506 causes the detected navigation controls to remain visually available within the viewing pane. For instance, the user interface and/or controls can be reconfigured in response to a viewing operation to continue to display detected navigation controls in visually available positions. Dynamic navigation controls can be displayed throughout performance of viewing operations that would otherwise cause the navigation controls to become visually unavailable if the controls were defined as static controls. Thus, dynamic navigation controls remain visually available before, during, and after different viewing operations. To accomplish this, portions of a page having dynamic navigation controls can be configured to operate and be displayed independently of the locations of a page in which they may appear initially or by default when the page is rendered. In contrast, statically defined content for a page can be bound to page locations. Thus, the availability of static content and controls is dependent upon whether corresponding page locations to which they are bound are visible or hidden.

In general, navigation controls can respond dynamically to viewing operations in accordance with associated behaviors that, at least in some cases, are described by control definitions 128. Behaviors can be used to specify different responses (e.g., scrolling, resizing, relocating, etc.) for navigation controls in connection with different viewing operations. In addition, different navigation controls can also have different behaviors in response to the same viewing operation. For example, based on the control definitions 128 for navigation controls that are detected in step 202, the client availability module 111 is able to determine behaviors specifying how to render the navigation controls in response to different operations. The client availability module 111 can make use of this information to cause a communication module 110 or other applications to render the navigation controls to remain available in accordance with behaviors designated for different viewing operations. For instance, the client availability module 111 can be configured to apply different behaviors specified for different controls when viewing operations corresponding to the behaviors are performed. In this manner, a client is able to implement dynamic navigation controls that remain visually available within a user interface for an application.

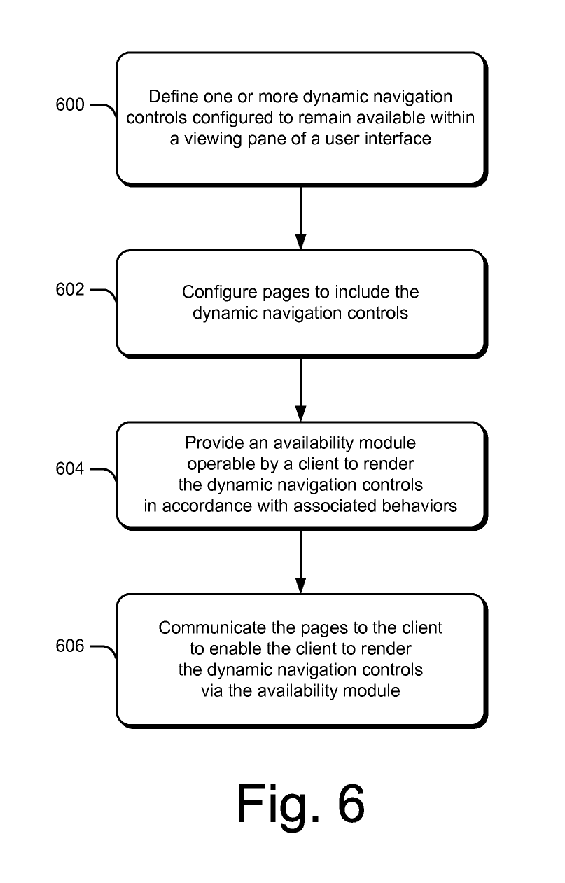

FIG. 6 is a flow diagram that describes steps of another method in which dynamic navigation controls for pages are defined and implemented to remain visually available within a user interface. In at least some embodiments, the method can be implemented by way of a suitably configured service provider, such as the example service provider 114 of FIG. 1 that includes or otherwise makes use of a navigation availability framework 126.

Step 600 defines one or more dynamic navigation controls configured to remain available within a viewing pane of a user interface. Various techniques can be employed to define dynamic navigation controls that can be selectively included within pages. In one approach, dynamic navigation control portions can be created using control definitions 128 as described above and below. Control definitions 128 can be implemented using any type of code suitable to define user interface elements including various user interface and/or graphical markup languages. In at least some embodiments, the control definitions 128 can be configured using XML based definition documents or templates for various controls. Control definitions 128 can include information to identify a corresponding control, attributes that define the look and feel of the control including a control's size, location, shape, color and so forth, and behaviors that are associated with the controls. Control definitions 128 can also describe control portions (e.g., a navigation bar or side bar) that include one or more individual controls.

The navigation availability framework 126 can be implemented to facilitate creation and management of control definitions 128. To do so, the navigation availability framework 126 can expose a development user interface through which page developers can access tools to define new controls, access and select pre-configured controls and templates, create pages that incorporate and/or reference the controls, and so forth. Thus, the development user interface can be used to define various controls and the navigation availability framework 126 can make the controls accessible for use in creating pages. This can include maintaining a database of controls that developers can access, download, and/or reference to produce pages.

Step 602 configures pages to include the dynamic navigation controls. For example, pages can be developed to include one or more portions having various navigation controls that are defined using control definitions 128 in the manner just described. The navigation availability framework 126 can enable association of pages with control definitions 128 in various ways. In one approach, control definitions 128 can be included directly within page definitions. Additionally or alternatively, pages can be configured to include references (e.g., URLs, XML or other mark-up code tags, links, and/or other suitable referencing data) to navigation control portions that can be obtained and rendered dynamically at runtime. The references can be configured to reference data defining controls from a database maintained “online” via a navigation availability framework 126. In another approach, a library of control definitions can be provided to a client 102 for local access to enable incorporation of corresponding navigation controls dynamically into pages when the pages are rendered.

Step 604 provides an availability module operable by a client to render the dynamic navigation controls in accordance with associated behaviors. A service provider 114 can provide an availability module for use by clients in any suitable way. For example, a navigation availability framework 126 can incorporate an availability module 130 that can be made accessible over a network 112. In at least some embodiments, the availability module 130 can be implemented as a web-hosted application that a client 102 can access and use over the network 112. A client 102 can also obtain an availability module 130 that can be installed at the client as a client availability module 111 by downloading from a provider, from storage on some form of computer-readable media, or otherwise. A client availability module 111 can also be provided to clients 102 as script that is contained in and/or referenced within pages. Accordingly, an availability module can be provided to clients 102 in these and other ways to provide an engine that, generally speaking, enables the clients 102 to interpret and render navigation controls and portions defined by the control definitions and implement associated behaviors defined for particular controls.

Step 606 communicates the pages to the client to enable the client to render the dynamic navigation controls via the availability module. For instance, pages having at least some dynamic navigation controls can be served via a resource manager module 120 to clients 102 in response to requests to access various resources 122 from a service provider 114. Naturally, offline pages of an application local to a client 102 can also be configured to contain dynamic navigation controls that operate in a comparable manner to controls in pages made available online. A communication module 110 (e.g., browser) or other application 108 of a client 102 can then render the pages, such as by outputting the pages within a corresponding user interface 124. The rendering of pages by a client can occur under the influence of a client availability module 111 (or availability module 130) that directs rendering of at least navigation controls within the pages. The availability module can further operate to cause designated controls to remain available within a user interface 124 in various ways specified using different behaviors. Dynamic navigation controls within a page can be prevented from becoming unavailable as long as the page is rendered in the user interface 124. In this manner, navigation controls for pages can be defined via the navigation availability framework 126 to remain visually available throughout presentation of corresponding pages within a viewing pane of an application.

Having considered various example methods for navigation control availability techniques, consider now an example system that can be employed to implement various techniques for navigation control availability in accordance with one or more embodiments.

Example System

FIG. 7 illustrates an example system generally at 700 that includes an example computing device 702 that is representative of one or more such computing systems and/or devices that may implement the various embodiments described above. The computing device 702 may be, for example, a server of a service provider 114, a device associated with the client 102 (e.g., a client device), an on-chip system, and/or any other suitable computing device or computing system.

The example computing device 702 includes one or more processors 704 or processing units, one or more computer-readable media 706 which may include one or more memory and/or storage components 708, one or more input/output (I/O) interfaces 710 for input/output (I/O) devices, and a bus 712 that allows the various components and devices to communicate one to another. Computer-readable media 706 and/or one or more I/O devices may be included as part of, or alternatively may be coupled to, the computing device 702. The bus 712 represents one or more of several types of bus structures, including a memory bus or memory controller, a peripheral bus, an accelerated graphics port, and a processor or local bus using any of a variety of bus architectures. The bus 712 may include wired and/or wireless buses.

The one or more processors 704 are not limited by the materials from which they are formed or the processing mechanisms employed therein. For example, processors may be comprised of semiconductor(s) and/or transistors (e.g., electronic integrated circuits (ICs)). In such a context, processor-executable instructions may be electronically-executable instructions. The memory/storage component 708 represents memory/storage capacity associated with one or more computer-readable media. The memory/storage component 708 may include volatile media (such as random access memory (RAM)) and/or nonvolatile media (such as read only memory (ROM)), flash memory, optical disks, magnetic disks, and so forth). The memory/storage component 708 may include fixed media (e.g., RAM, ROM, a fixed hard drive, etc.) as well as removable media (e.g., a Flash memory drive, a removable hard drive, an optical disk, and so forth).

Input/output interface(s) 710 allow a user to enter commands and information to computing device 702, and also allow information to be presented to the user and/or other components or devices using various input/output devices. Examples of input devices include a keyboard, a cursor control device (e.g., a mouse), a microphone, a scanner, and so forth. Examples of output devices include a display device (e.g., a monitor or projector), speakers, a printer, a network card, and so forth.

Various techniques may be described herein in the general context of software, hardware (fixed logic circuitry), or program modules. Generally, such modules include routines, programs, objects, elements, components, data structures, and so forth that perform particular tasks or implement particular abstract data types. An implementation of these modules and techniques may be stored on or transmitted across some form of computer-readable media. The computer-readable media may include a variety of available medium or media that may be accessed by a computing device. By way of example, and not limitation, computer-readable media may include “computer-readable storage media” and “communication media.”

“Computer-readable storage media” refers to media and/or devices that enable persistent and/or non-transitory storage of information in contrast to mere signal transmission, carrier waves, or signals per se. Thus, computer-readable storage media can refer to non-signal bearing media. Computer-readable storage media also includes hardware elements having instructions, modules, and/or fixed device logic implemented in a hardware form that may be employed in some embodiments to implement aspects of the described techniques.

The computer-readable storage media includes volatile and non-volatile, removable and non-removable media and/or storage devices implemented in a method or technology suitable for storage of information such as computer readable instructions, data structures, program modules, logic elements/circuits, or other data. Examples of computer-readable storage media include, but are not limited to, RAM, ROM, electrically erasable programmable ROM (EEPROM), flash memory or other memory technology, compact disk ROM (CD-ROM), digital versatile disks (DVD) or other optical storage, hard disks, magnetic cassettes, magnetic tape, magnetic disk storage or other magnetic storage devices, hardware elements (e.g., fixed logic) of an integrated circuit or chip, or other storage device, tangible media, or article of manufacture suitable to store the desired information and which may be accessed by a computer.

“Communication media” refers to a signal bearing medium that is configured to transmit instructions to the hardware of the computing device, such as via the network 112. Communication media typically may embody computer readable instructions, data structures, program modules, or other data in a modulated data signal, such as carrier waves, data signals, or other transport mechanism. Communication media also include any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, RF, infrared, and other wireless media.

Combinations of any of the above are also included within the scope of computer-readable media. Accordingly, software, hardware, or program modules, including the resource manager module 120, applications 108, communication module 110, client availability module 111, availability module 130, and other program modules, may be implemented as one or more instructions and/or logic embodied on some form of computer-readable media.

Accordingly, particular modules, functionality, components, and techniques described herein may be implemented in software, hardware, firmware and/or combinations thereof. The computing device 702 may be configured to implement particular instructions and/or functions corresponding to the software and/or hardware modules implemented on computer-readable media. The instructions and/or functions may be executable/operable by one or more articles of manufacture (for example, one or more computing devices 702 and/or processors 704) to implement techniques for navigation control availability, as well as other techniques. Such techniques include, but are not limited to, the example procedures described herein. Thus, computer-readable media may be configured to store or otherwise provide instructions that, when executed by one or more devices described herein, cause various techniques for navigation control availability.

### CONCLUSION

Techniques for navigation control availability have been described herein. The described techniques provide dynamic navigation controls that are configured to remain available throughout viewing operations, such as scrolling or resizing. In response to such viewing operations, the dynamic navigation controls can be adjusted in different ways to remain visually available. This can involve docking, relocating, and/or resizing of the controls in accordance with associated behaviors.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claimed features.

What is claimed is:

1. A computer implemented method comprising:
detecting navigation controls included within a page that are displayable in a viewing pane of a user interface; and
causing the navigation controls to remain visually available within the viewing pane throughout a viewing operation that otherwise would cause the navigation controls to become hidden in a display of the page in the viewing pane.

2. The computer implemented method of claim 1, wherein the navigation controls comprise at least one of:
global navigation controls configured to facilitate navigation of a domain associated with the page on a domain wide level; or
local navigation controls configured to facilitate interaction with content of the page and navigation within the page.

3. The computer implemented method of claim 1, wherein the viewing operation comprises scrolling of the page to display a different location of the page within the viewing pane.

4. The computer implemented method of claim 1, wherein the viewing operation comprises resizing of the viewing pane that results in at least some content portions displayed in the viewing pane to become hidden.

5. The computer implemented method of claim 1, wherein the viewing operation comprises selection of a bookmark to display a different location of the page within the viewing pane.

6. The computer implemented method of claim 1, wherein causing the detected navigation controls to remain visually available comprises docking at least one navigation control at a defined boundary point in the viewing pane.

7. The computer implemented method of claim 1, wherein causing the detected navigation controls to remain visually available comprises relocating at least one navigation control to a different position within the viewing pane.

8. The computer implemented method of claim 1, wherein causing the detected navigation control portions to remain visually available comprises resizing at least one navigation control to fill space created within the viewing pane when other content portions are hidden in response to the viewing operation.

9. The computer implemented method of claim 1, wherein:
the detecting comprises parsing the page to identify control definitions for the navigation controls that are associated with behaviors specifying ways in which the navigation controls respond to different viewing operations; and
the causing the detected navigation controls to remain visually available comprises applying the behaviors to the navigation controls when the viewing operation occurs to prevent the navigation controls from becoming unavailable due to the viewing operation.

10. The computer implemented method of claim 9, wherein the behaviors are triggered in response to different viewing operations to cause one or more of docking, relocating, or resizing of corresponding navigation control portions.

11. One or more computer-readable storage media storing instructions, that when executed by a computing device, cause the computing device to implement an availability module configured to perform acts comprising:
obtaining a webpage that is displayable in a viewing pane of a browser;
parsing the webpage to identify control definitions for navigation controls that are associated with behaviors configured to specify ways in which the navigation controls respond to different viewing operations; and
reconfiguring the webpage in accordance with the behaviors to prevent the navigation controls from becoming unavailable when different viewing operations occur that cause locations of the webpage in which the navigation controls initially appear to become hidden.

12. The one or more computer-readable storage media of claim 11, wherein the behaviors are configured to cause one or more of docking, relocating, or resizing of associated navigation controls within the viewing pane to keep the navigation controls visually available.

13. The one or more computer-readable storage media of claim 11, wherein the navigation controls include at least global navigation controls configured to facilitate navigation of a site associated with the webpage and local navigation controls configured to facilitate interaction with particular content provided by the webpage.

14. The one or more computer-readable storage media of claim 11, wherein the different viewing operations include scrolling of the webpage, resizing of the viewing pane of the browser, and selection of a bookmark to navigate to a location within the webpage.

15. The one or more computer-readable storage media of claim 11, wherein the control definitions for the navigation controls are included within a page definition for the webpage.

16. The one or more computer-readable storage media of claim 11, wherein the webpage includes references to the control definitions for the navigation controls that enable the availability module to retrieve the control definitions from an external source.

17. The one or more computer-readable storage media of claim 11, wherein the reconfiguring comprises applying one or more of the behaviors to at least one navigation control to render the at least one navigation control independently of a location of the webpage at which the at least one navigation control is configured to appear by default.

18. A system comprising:
one or more processors;
one or more computer-readable storage media storing instructions, that when executed via the one or more processors, implement a navigation availability framework configured to perform acts comprising:
defining global and local navigation controls for pages that are configured to remain visually available within a user interface for a client application operable to display the pages using behaviors associated with the global and local navigation controls, the behaviors to specify responses of the global and local navigation controls to viewing operations;
configuring pages for the client application to include the global and local navigation controls; and
communicating at least one page to a client to enable the client application to render the page in accordance with the behaviors to display the global and local navigation controls in visually available positions within the user interface throughout presentation of the page, including when locations of the page in which the global and local navigation controls initially appeared are hidden due to the viewing operations.

19. The system of claim 18, wherein the navigation availability framework is further configured to perform acts comprising communicating an availability module to the client for operation locally at the client to apply the behaviors.

20. The system of claim 18, wherein the navigation availability framework is further configured to perform acts comprising providing an availability module as a web-hosted application operable by the client over a network to apply the behaviors.
